(19) United States
(12) Patent Application Publication
(10) Pub. No.: US 2005/0220310 A1
(43) Pub. Date: Oct. 6, 2005

(54) Technique and device for through-the-wall audio surveillance

(76) Inventor: William R. McGrath, Monrovia, CA (US)

Correspondence Address: CHRISTIE, PARKER & HALE, LLP, PO BOX 7068, PASADENA, CA, 91109-7068, US

(21) Appl. No.: 11/095,122

(22) Filed: Mar. 30, 2005

Related U.S. Application Data
(60) Provisional application No. 60/557,542, filed on Mar. 30, 2004.

(51) Int. Cl. H04R 29/00

(52) U.S. Cl. 381/56

(57) ABSTRACT

Systems and methods are disclosed for detecting audible sound and/or the vibration of objects. Embodiments of the present invention are able to detect sound and other vibrations through barriers. One embodiment of the invention includes an RF transmitter configured to generate an RF signal having a frequency of at least 100 MHz and an unmodulated amplitude, an RF receiver configured to receive a reflected RF signal comprising an RF carrier having the same frequency as the generated RF signal that is amplitude modulated by an information signal and a signal processor configured to extract audio frequency information from the amplitude of the reflected RF signal.

### CROSS-REFERENCE TO RELATED APPLICATION(S)

This application claims priority based on U.S. Provisional Application No. 60/557,542 filed Mar. 30, 2004.

### STATEMENT REGARDING FEDERALLY SPONSORED RESEARCH OR DEVELOPMENT

The U.S. Government has certain rights in this invention pursuant to NAS7-1407 provided by the National Aeronautics and Space Administration, Office of Space Science.

### BACKGROUND

The present invention generally relates to the detection of audible sound and more specifically relates to the detection of sound through an interposed barrier.

Audio surveillance is an important part of law enforcement activity. The ability to overhear conversations can provide vital information relating to the commission of a crime. One method of detecting sound is to place a microphone proximate the source of the sound. Sound is essentially a pressure wave and the microphone detects sound by detecting fluctuations in pressure associated with the pressure wave.

Attempts to detect sound using a microphone can be frustrated by interposing a barrier between the source of the sound and the microphone. In instances where the barrier absorbs the energy of the sound pressure waves, then a microphone can experience difficulty in detecting the sound. In addition, a space can be “sound-proofed” to frustrate audio surveillance. Sound-proofing describes constructing barriers that effectively prevent pressure waves associated with sound from escaping a space.

### SUMMARY OF THE INVENTION

Embodiments of the present invention can detect vibrations of objects including slight vibrations caused by sound pressure waves. In one aspect of the present invention an object is illuminated with a monochromatic RF beam that does not include any amplitude modulation. Observations of amplitude modulations in reflections of the RF beam can provide information concerning vibrations or movements of the object. Audio information can be extracted from the amplitude modulated information and used to reproduce any sound pressure waves incident on the object.

One embodiment of the invention includes an RF transmitter configured to generate an RF signal having a frequency of at least 100 MHz and an unmodulated amplitude, an RF receiver configured to receive a reflected RF signal comprising an RF carrier having the same frequency as the generated RF signal that is amplitude modulated by an information signal and a signal processor configured to extract audio frequency information from the amplitude of the reflected RF signal.

In another embodiment of the invention, the RF transmitter includes an RF synthesizer coupled to an antenna.

In a further embodiment of the invention, the antenna is a planar antenna. In yet another embodiment of the invention, the antenna is a waveguide horn antenna.

In a still further embodiment, the RF receiver includes an antenna, a low noise amplifier coupled to the antenna, a harmonic mixer connected to an output of the low noise amplifier and to an RF oscillator, a second amplifier connected to an output of the harmonic mixer, a narrow bandpass filter connected to an output of the second amplifier and a diode detector connected to an output of the narrow bandpass filter.

In yet another embodiment of the invention again, the antenna is a planar antenna. In a still further embodiment of the invention again, the antenna is a waveguide horn antenna.

In yet another additional embodiment, the low noise amplifier is implemented using MMIC.

In a still further additional embodiment the signal processor includes an audio speaker. In still yet another embodiment, the RF signal can have a frequency in the range of 100 MHz to 200 GHz. Moreover, the RF signal can have a frequency in the range of 1 GHz to 100 GHz. In addition, the RF signal can have a frequency in the range of 10 GHz to 100 GHz.

An embodiment of the method of the invention includes illuminating an object with a generated RF signal having a frequency of at least 100 MHz and having an unmodulated amplitude, extracting amplitude modulated information from reflections of the generated RF signal, isolating the portions of the extracted information corresponding to audio frequencies and generating audio using the isolated portions of the extracted information.

In another embodiment of the method of the invention, the RF signal has a frequency in the range of 100 MHz to 200 GHz. Moreover, the RF signal can have a frequency in the range of 1 GHz to 100 GHz. In addition, the RF signal can have a frequency in the range of 10 GHz to 100 GHz.

### BRIEF DESCRIPTION OF THE DRAWINGS

FIG. 1A is a schematic diagram of a sound detection system in accordance with an embodiment of the present invention illuminating an object with an RF beam through a barrier;

FIG. 1B is a schematic diagram of a sound detection system in accordance with an embodiment of the present invention illuminating the chest of a subject with an RF beam;

FIG. 2 is a schematic circuit diagram of a system in accordance with an embodiment of the present invention;

FIG. 3 is a schematic diagram of an experimental configuration;

FIGS. 4A and 4B are graphs showing comparisons between audio signal amplitudes and the amplitude modulation of an RF signal detected in accordance with an embodiment of the method of the present invention, where the RF signal is reflected from an aluminum foil upon which the audio signal pressure waves are incident;

FIGS. 4C and 4D are graphs showing comparisons of audio signal amplitudes and the amplitude modulation of an RF signal obtained in a similar manner to the graphs shown in FIGS. 4A and 4B with the exception that a plywood barrier is interposed between the sound detection system and the aluminum foil; and

FIG. 5 is a schematic diagram of an embodiment of a sound detection system in accordance with the present invention that includes an RF source separate from an RF detector.

### DETAILED DESCRIPTION OF THE INVENTION

Embodiments of the present invention use reflected electromagnetic signals to detect audible sound. Pressure waves incident on an object can cause the object to vibrate in a manner indicative of the pressure waves. Electromagnetic radiation reflected by a vibrating object can include an amplitude modulated component indicative of the object's vibrations. Several embodiments of the present invention illuminate objects with an RF signal that does not have a modulated amplitude and extract amplitude modulated information from reflections of the RF signal. In many embodiments, the amplitude modulated information includes information indicative of pressure waves incident on the object. Analysis of the signals indicative of pressure waves can then be performed to reproduce any audible sounds included in the pressure waves.

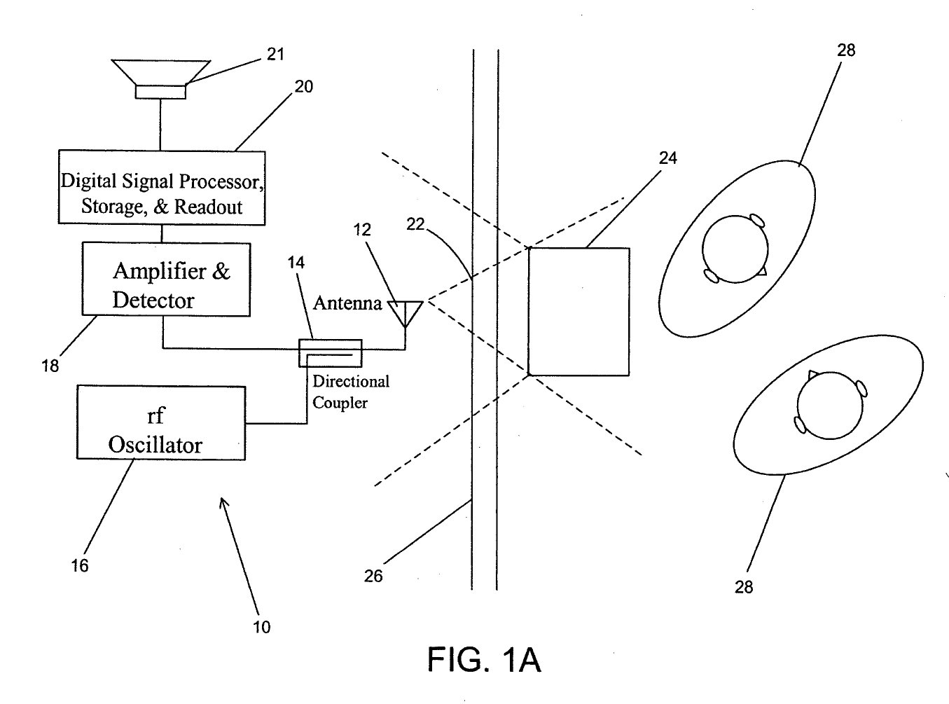

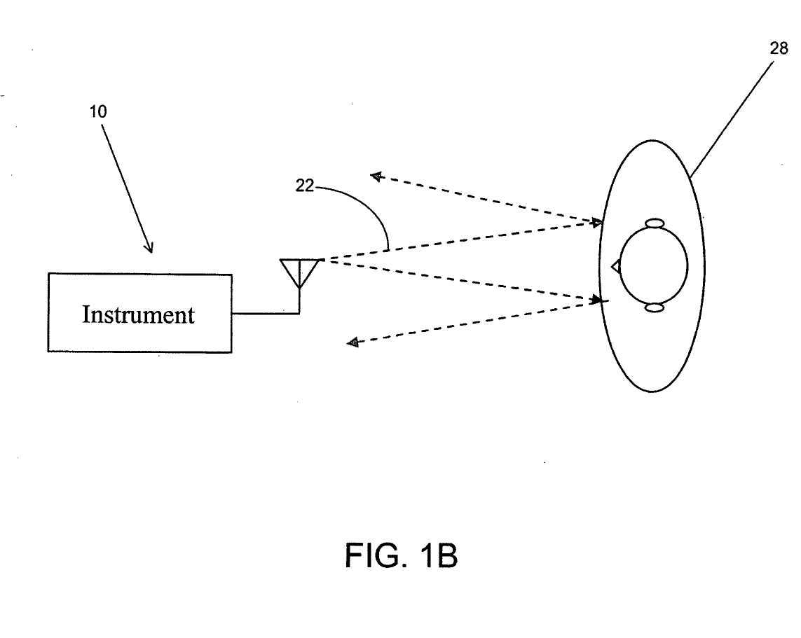

Turning now to the diagrams, FIG. 1 illustrates a sound detection system 10 in accordance with the present invention that includes an antenna 12 coupled via a directional coupler 14 to an RF oscillator 16 and a RF detector 18. In addition, the RF detector is connected to a digital signal processor 20 which is connected to a speaker 21. The RF oscillator and the antenna can illuminate an object 24 with an electromagnetic beam 22. The object typically reflects a portion of the incident electromagnetic signal and the antenna and the RF detector can be used to generate a signal indicative of the amplitude of the reflected signal. The amplitude of the reflected signal may be modulated if the object is vibrating. Information can then be extracted from the signal generated by the antenna and the RF detector by the digital signal processor.

In the illustrated embodiment, a barrier 26 separates the sound detection system 10 and the object 24. In addition, two people 28 are conducting a conversation proximate the object. Pressure waves generated as the people speak are incident on the object causing it to vibrate. As indicated above, these vibrations can modulate the amplitude of the RF beam reflections from the object.

In one embodiment, the reflected signal is received by the antenna, amplified by a low noise amplifier and detected by a total-power direct detector with a bandwidth of at least several 10's of kilohertz to accommodate audio information. A real time digital signal processor can then be used to recover the audio information and convert the audio information to an analog signal for amplification and output to a loud speaker. In several embodiments, signal processing techniques similar to those used with laser sound detection systems can be employed.

In one embodiment, the sound detection system generates a monochromatic RF beam using a planner antenna having a frequency within the range of 100 MHz to 200 GHz. In other embodiments, the RF beam can have a frequency within the range 1 GHz to 100 GHz. In further embodiments, the RF beam can have a frequency within the range of 10 GHz to 200 GHz As will be discussed below, other antenna configurations can be used such as horn antennas. The frequency of the RF beam can be less than 100 MHz, however, antenna size may increase and the beam may have a width that encompass a very wide field.

An embodiment of a sound detection system in accordance with the present invention that can be used to detect sound by observing RF reflections from the chest of a human subject is shown in FIG. 1A. A sound detection system 10 is shown generating an RF beam 22 that is illuminating the chest of a human subject 28. The subject's chest reflects the beam and the RF beam's reflections can be amplitude modulated by, amongst other things, a component indicative of any sound being generated by the subject.

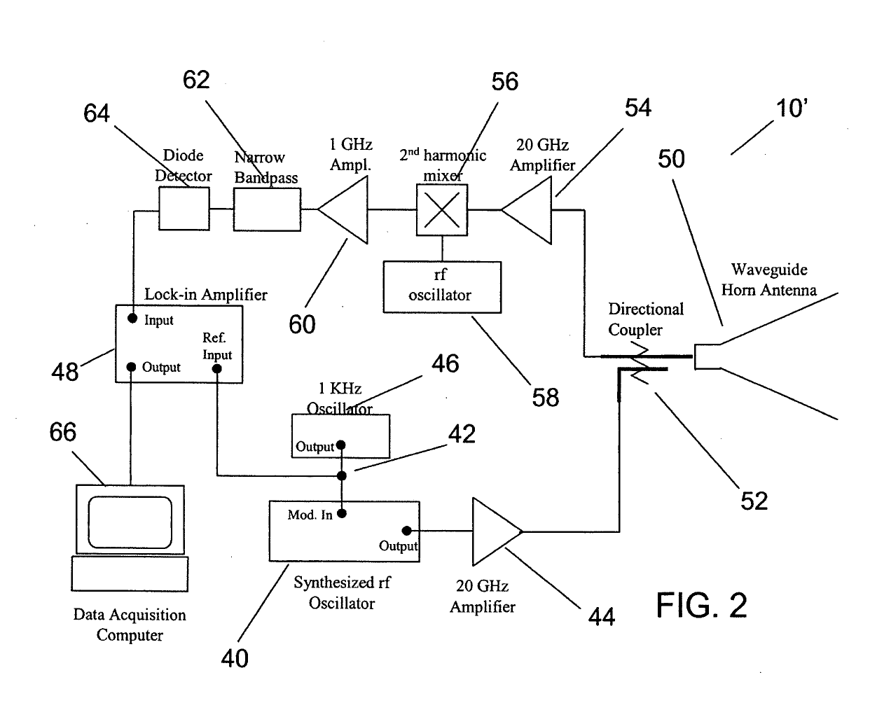

A diagram of a sound detection system in accordance with the present invention is shown in FIG. 2. The sound detection system 10′ includes a synthesized RF oscillator 40 that is connected to a common node 42 and a first amplifier 44. The common node 42 is connected to an oscillator 46 and a lock-in amplifier 48. The output of the first amplifier 44 is connected to an antenna 50 via a directional coupler 52. The directional coupler is also connected to a second amplifier 54. The output of the second amplifier is connected to a mixer 56. An RF oscillator 58 also provides an output to the mixer. The output of the mixer is connected to the input of a third amplifier 60. The output of the third amplifier is connected to a bandpass filter 62 and the output of the bandpass filter is connected to a diode detector 64. An output of the diode detector is connected to an input of the lock-in amplifier 48 and the output of the lock-in amplifier is then provided to a data acquisition computer 66. In several embodiments, the data acquisition computer includes a speaker. Although the illustrated embodiment uses a lock-in amplifier, the lock-in amplifier may not be necessary as can be seen from the embodiments as discussed below.

In many embodiments, the RF components of sound detection systems in accordance with the present invention can be fabricated using MMIC technology. Such circuits could cover an area at least as small as several square inches. The RF circuitry can be combined with digital signal processing boards or field programmable gate arrays to perform signal processing functions. The antenna can be constructed using a planar integrated-circuit antenna, such as a microstrip patch array. In one embodiment, an antenna designed for use with a 30 GHz RF signal can be constructed using a patch-array antenna that is approximately 4 inches on a side. Such an antenna can produce a transmitted beam approximately 3 feet wide at a distance of 26 feet. A 3-foot wide beam is typically sufficient to localize a single person or a convenient adjacent reflecting surface. If localization is not an issue, then a similarly small antenna system can be useful up to tens of meters. For situations where the antenna size is not important, a larger array can be used. The effective range of a beam scales approximately with the antenna size and transmitted power. In addition, use of higher frequencies allows for reduced antenna size. Higher frequencies, typically, do not penetrate barriers as effectively as lower frequencies. Reflected signals can be very weak, but microwave amplifiers can be designed and built with a noise level of only 0.1 pW for a 20 MHz bandwidth. Thus a transmitted signal of 100 mW can be attenuated on the round trip path by up to 120 dB before the signal-to-noise ratio drops to 1. Using frequencies near 100 GHz, would provide a narrow-beam, ≈1° wide, for an antenna with only a 4-inch aperture.

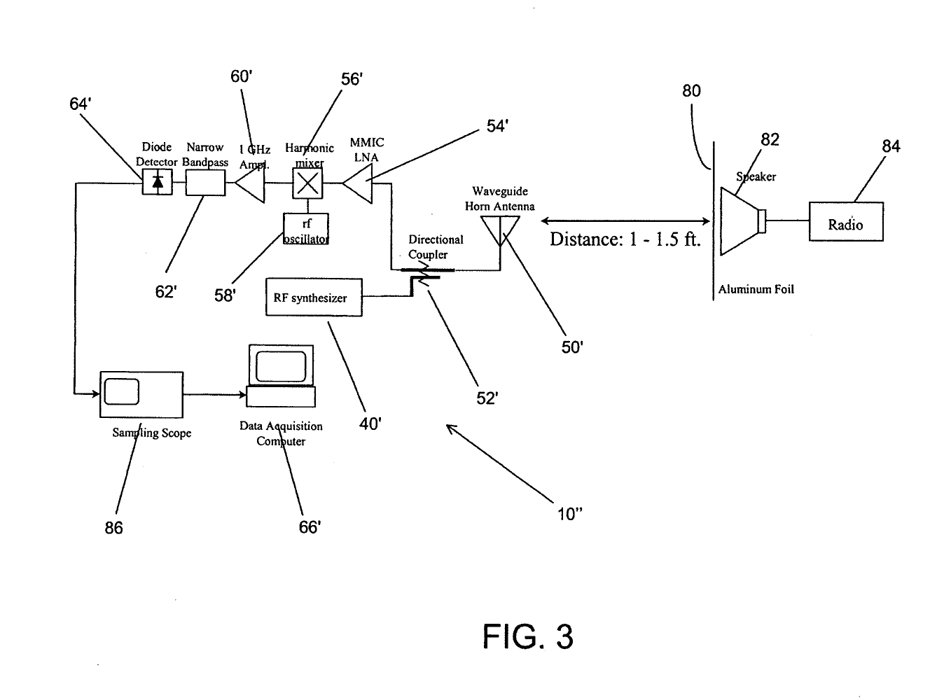

An embodiment of a sound detection system in accordance with the present invention configured to detect vibrations of an aluminum foil is shown in FIG. 3. In the illustrated configurations, the sound detection system 10″ is positioned a distance of approximately 1 foot from an aluminum foil 80. A speaker 82 is positioned on the other side of the foil and directs sound pressure waves at the foil. The speaker is capable of generating sound because it is connected to a radio 84. The sound detection system 10″ can detect movement of the foil by directing an RF beam at the foil.

In the illustrated embodiment, the sound detection system 10″ includes an RF synthesizer 40′ connected to an antenna 50′ via a directional coupler 52′. The directional coupler is also connected to a low noise amplifier 54′, which in this instance is implemented using MMIC technology. The output of the low noise amplifier is provided to a harmonic mixer 56′, which is connected to an RF oscillator 58′ and a second amplifier 60′. An output from the second amplifier is provided to a narrow band filter 62′, which in turn provides an output to a diode detector 64′. The diode detector is connected to a sampling scope 86, which is connected to a data acquisition computer 66′. In one embodiment, the RF beam generated by the sound detection system is a monochromatic, has a frequency of 18 GHz and a amplitude that is unmodulated. The sound detection system 10″ observes reflections of the RF beam from the aluminum foil using the antenna 50 and the signal is processed in accordance with the description above. In several embodiments, the power of the RF beam can be of the order of several milliwatts. The reflected signal can be fed to the low-noise 18 GHz amplifier 54′. The signal can then be heterodyned down to 1 GHz and bandpass filtered to 2 MHz to reduce the overall system noise. The detected signal can then be displayed on the sampling scope 86 or simply digitized and stored on a computer. Simultaneously, the audio signal from the radio can also be digitized and stored for comparison with the microwave response.

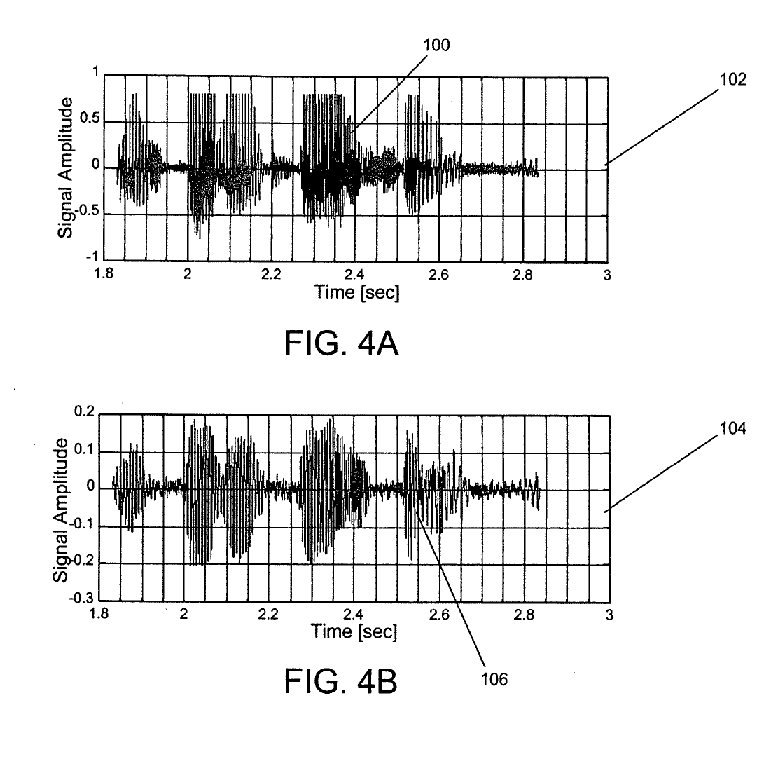

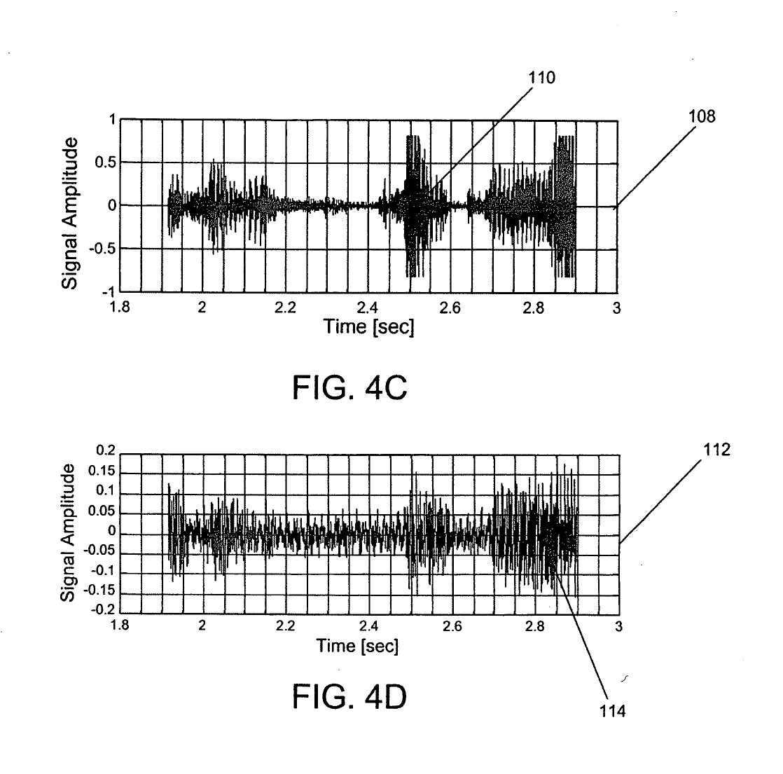

A graph showing the amplitude of audio signal incident on the aluminum foil shown in FIG. 3 is illustrated in FIG. 4A. The graph 100 charts 102 the signal amplitude as a function of time. The signal itself was generated by tuning the radio 84 shown in FIG. 3 to a talk radio station.

A graph showing the output of the sound detection system illustrated in FIG. 3, when the audio signal shown in FIG. 4A is incident on the aluminum foil 80 shown in FIG. 3, is illustrated in FIG. 4B. The graph 104 charts 106 the output obtained by the sound detection system in accordance with the process described above against time.

As discussed above, embodiments of sound detection systems in accordance with the present invention can detect sounds through barriers. In one instance, a plywood barrier having a thickness of 0.75 inches was interposed between the sound detection device 10″ and the aluminum barrier 80 shown in FIG. 3. A graph 108 charting 110 the audio signal incident on the barrier is shown in FIG. 4C. A graph 112 charting 114 the output generated by the sound detection system in accordance with the processes of the present invention, when the RF beam generated by the sound detection system must pass through the plywood barrier described above, is shown in FIG. 4D. The microwave beam can penetrate the plywood barrier 80 and be modulated by the vibrations of the foil caused by the audio signal pressure waves.

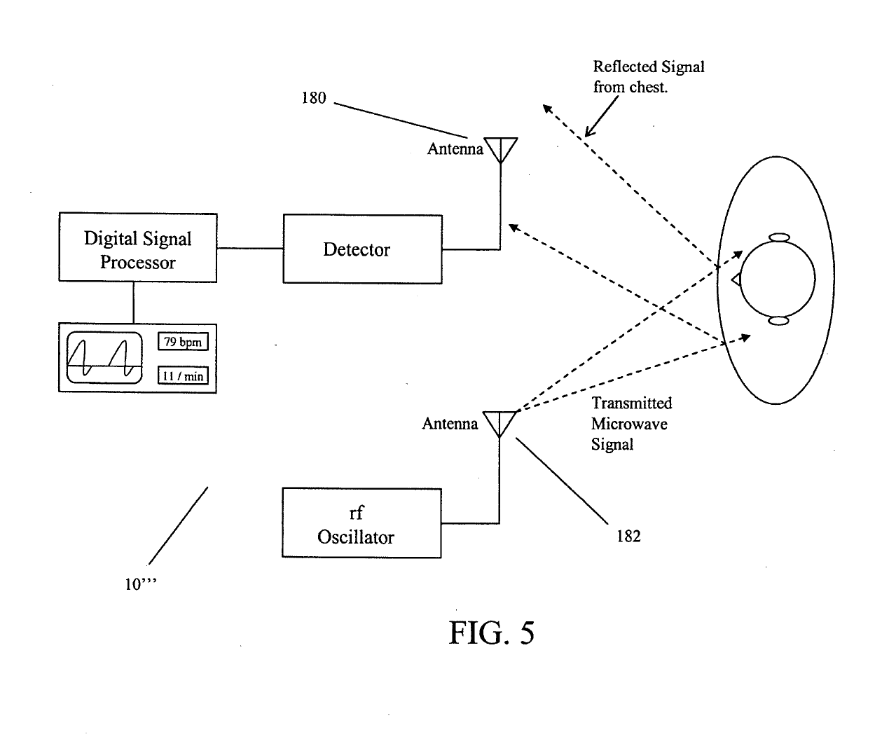

An embodiment of a sound detection system in accordance with the present invention that includes separate antennas for illuminating a subject and for receiving reflections is illustrated in FIG. 5. The remote detection system 10′″ is similar to the embodiment illustrated in FIG. 1, except that a first antenna 180 is used to generate an electromagnetic signal beam and a second antenna 182 is used to detect the reflected electromagnetic signal beam.

While the above description contains many specific embodiments of the invention, these should not be construed as limitations on the scope of the invention, but rather as an example of one embodiment thereof. Many other variations are possible, including implementing sound detections systems in accordance with the present invention using planar antennas and MMIC manufacturing techniques. In addition, vibrations of objects associated with pressure wave other than sound pressure waves can be monitored. Accordingly, the scope of the invention should be determined not by the embodiments illustrated, but by the appended claims and their equivalents.

1. A device for detecting audible sound, comprising:
an RF transmitter configured to generate an RF signal having a frequency of at least 100 MHz and an unmodulated amplitude;
an RF receiver configured to receive a reflected RF signal comprising an RF carrier having the same frequency as the generated RF signal that is amplitude modulated by an information signal; and
a signal processor configured to extract audio frequency information from the amplitude of the reflected RF signal.

2. The device of claim 1, wherein the RF transmitter comprises an RF synthesizer coupled to an antenna.

3. The device of claim 2, wherein the antenna is a planar antenna.

4. The device of claim 2, wherein the antenna is a waveguide horn antenna.

5. The device of claim 1, wherein the RF receiver comprises:
an antenna;
a low noise amplifier coupled to the antenna;
a harmonic mixer connected to an output of the low noise amplifier and to an RF oscillator;
a second amplifier connected to an output of the harmonic mixer;
a narrow bandpass filter connected to an output of the second amplifier; and
a diode detector connected to an output of the narrow bandpass filter.

6. The device of claim 5, wherein the antenna is a planar antenna.

7. The device of claim 5, wherein the antenna is a waveguide horn antenna.

8. The device of claim 5, wherein the low noise amplifier is implemented using MMIC.

9. The device of claim 1, wherein the signal processor includes an audio speaker.

10. The device of claim 1, wherein the RF signal has a frequency in the range of 100 MHz to 200 GHz.

11. The device of claim 1, wherein the RF signal has a frequency in the range of 1 GHz to 100 GHz.

12. The device of claim 1, wherein the RF signal has a frequency in the range of 10 GHz to 100 GHz.

13. A method of reproducing an audible sound, comprising:
illuminating an object with a generated RF signal having a frequency of at least 100 MHz and having an unmodulated amplitude;
extracting amplitude modulated information from reflections of the generated RF signal;
isolating the portions of the extracted information corresponding to audio frequencies; and
generating audio using the isolated portions of the extracted information.

14. The device of claim 13, wherein the RF signal has a frequency in the range of 100 MHz to 200 GHz.

15. The device of claim 13, wherein the RF signal has a frequency in the range of 1 GHz to 100 GHz.

16. The device of claim 13, wherein the RF signal has a frequency in the range of 10 GHz to 100 GHz.

17. A system for determining the frequency with which an object vibrates, comprising:
means for generating an RF signal having a frequency of at least 100 MHz;
means for receiving reflections of the RF signal reflected by the object; and
means for demodulating the received RF signal to extract a signal indicative of the frequency with which the object is vibrating.

18. The system of claim 17, further comprising means for generating an audio signal indicative of the audio frequency components of the extracted signal.
